(19) United States
(12) Patent Application Publication
(10) Pub. No.: US 2026/0030788 A1
(43) Pub. Date: Jan. 29, 2026

(54) ENCODING METHOD, DECODING METHOD, ENCODER AND DECODER

(71) Applicant: GUANGDONG OPPO MOBILE TELECOMMUNICATIONS CORP., LTD., Dongguan, Guangdong (CN)

(72) Inventors: Vladyslav ZAKHARCHENKO, Palo Alto, CA (US); Yue YU, Palo Alto, CA (US); Haoping YU, Palo Alto, CA (US)

(21) Appl. No.: 19/123,134

(22) PCT Filed: Oct. 22, 2023
(86) PCT No.: PCT/US2023/077495

§ 371 Date: Apr. 22, 2025

Related U.S. Application Data
(60) Provisional application No. 63/419,281, filed on Oct. 25, 2022.

(51) Int. Cl. G06T 9/00; G06T 7/11

(52) U.S. Cl. CPC G06T 9/001; G06T 7/11

(57) ABSTRACT

An encoding method is provided and includes: obtaining a volumetric mesh; performing mesh segmentation of the volumetric mesh to generate multiple segments of mesh content; performing mesh decimation of a segment of mesh content to generate a base mesh; performing mesh subdivision of the base mesh to generate multiple subdivided base meshes; calculating multiple mesh displacements between the multiple subdivided base meshes and an original volumetric mesh surface to generate multiple transformed displacement coefficients; converting the multiple transformed displacement coefficients to multiple quantized transformed displacement coefficients; scanning the multiple quantized transformed displacement coefficients along a three-dimensional space scanning pattern within each level-of-detail to form three one-dimensional arrays; and re-arranging the multiple quantized transformed displacement coefficients in the three one-dimensional arrays to a two-dimensional image according to the each level-of-detail and a packing order indicated by a specific flag.

### CROSS-REFERENCE TO RELATED APPLICATION

This application is a national phase entry under 35 USC 371 of International Patent Application No. PCT/US2023/077495 filed on Oct. 22, 2023, which claims the priority benefit of U.S. provisional application Ser. No. 63/419,281, filed on Oct. 25, 2022. The entireties of the above-mentioned patent applications are hereby incorporated by reference herein and made a part of this specification.

### BACKGROUND

### Technical Field

The present invention relates to the field of image data processing, and specifically, to an encoding method, a decoding method, an encoder and a decoder.

### Description of Related Art

For traditional image coding, the process of the mapping the three-dimensional displacement coefficients to the two-dimensional image and further video coding does not allow to clearly distinguish the samples in the image that belong to a specified level of details. This requires to allocate maximum memory even for a partial reconstruction scenario.

### SUMMARY

The encoding method of the invention includes the following steps: obtaining, by a processor, a volumetric mesh; performing, by the processor, mesh segmentation of the volumetric mesh to generate a segment of mesh content; performing, by the processor, mesh decimation of the segment of mesh content to generate a base mesh; performing, by the processor, mesh subdivision of the base mesh to generate a subdivision of the volumetric mesh; calculating, by the processor, a plurality of mesh displacements between the subdivision of the volumetric mesh and an original volumetric mesh surface to generate a plurality of transformed displacement coefficients; converting, by the processor, the plurality of transformed displacement coefficients to a plurality of quantized transformed displacement coefficients; scanning, by the processor, the plurality of quantized transformed displacement coefficients along a three-dimensional space scanning pattern within each level-of-detail to form three one-dimensional arrays; and re-arranging, by the processor, the plurality of quantized transformed displacement coefficients in the three one-dimensional arrays to a two-dimensional image according to the each level-of-detail and a packing order indicated by a specific flag.

In an embodiment of the invention, in response to the specific flag being equal to 0, the packing order is an increasing level-of-detail order, and in response to the specific flag being equal to 1, the packing order is a decreasing level-of-detail order.

In an embodiment of the invention, the plurality of transformed displacement coefficients are converted to a fix-point representation with a precision indicated in a coded bitstream.

In an embodiment of the invention, the three-dimensional space scanning pattern is a Morton space filling curve or a Hibert space filling curve.

In an embodiment of the invention, the two-dimensional image is composed of a plurality of coding tree units.

In an embodiment of the invention, in response to the two-dimensional image including at least one unoccupied symbol, the at least one unoccupied symbol is padded.

In an embodiment of the invention, the at least one unoccupied symbol is padded by zero-padding.

The encoder of the invention includes a communication interface, a storage device and a processor. The communication interface is configured to receive a volumetric mesh. The storage device is configured to store a geometry bitstream. The processor, electrically connected to the communication interface and the storage device, and configured to encode the volumetric mesh to generate the geometry bitstream. The processor is configured to perform mesh segmentation of the volumetric mesh to generate a segment of mesh content, and the processor is configured to perform mesh decimation of the segment of mesh content to generate a base mesh. The processor is configured to perform mesh subdivision of the base mesh to generate a subdivision of the volumetric mesh. The processor is configured to calculate a plurality of mesh displacements between the subdivision of the volumetric mesh and an original volumetric mesh surface to generate a plurality of transformed displacement coefficients, and the processor is configured to convert the plurality of transformed displacement coefficients to a plurality of quantized transformed displacement coefficients. The processor is configured to scan the plurality of quantized transformed displacement coefficients along a three-dimensional space scanning pattern within each level-of-detail to form three one-dimensional arrays, and the processor is configured to re-arrange the plurality of quantized transformed displacement coefficients in the three one-dimensional arrays to a two-dimensional image according to the each level-of-detail and a packing order indicated by a specific flag.

The decoding method of the invention includes the following step: obtaining, by a processor, a geometry bitstream; decoding, by the processor, a base mesh from the geometry bitstream; recursively subdividing, by the processor, the base mesh to a level-of-detail; obtaining, by the processor, a coded bitstream for a plurality of mesh displacements from the base mesh recursively subdivided to the level-of-detail; decoding, by the processor, the coded bitstream with a codec corresponding to a mesh codec identification of the decoder to obtain a plurality of transformed displacement coefficients; processing, by the processor, the plurality of transformed displacement coefficients with an inverse displacement transform to generate the plurality of mesh displacements; and applying, by the processor, the plurality of mesh displacements to the recursively subdivided base mesh to generate a reconstructed mesh including blocks representing individual region of interest.

In an embodiment of the invention, the plurality of transformed displacement coefficients is converted from a plurality of quantized transformed displacement coefficients, and the plurality of quantized transformed displacement coefficients is coded in a two-dimensional image. The two-dimensional image is generated according to each level-of-detail and a packing order indicated by a specific flag.

In an embodiment of the invention, in response to the specific flag being equal to 0, the packing order is an increasing level-of-detail order, and in response to the specific flag being equal to 1, the packing order is a decreasing level-of-detail order.

In an embodiment of the invention, the two-dimensional image is composed of a plurality of coding tree units.

In an embodiment of the invention, in response to the two-dimensional image including at least one unoccupied symbol, the at least one unoccupied symbol is padded.

In an embodiment of the invention, the at least one unoccupied symbol is padded by zero-padding.

The decoder of the invention includes a communication interface, a storage device and a processor. The communication interface is configured to receive an encoded volumetric mesh including a geometry bitstream. The storage device is configured to store the encoded volumetric mesh. The processor is electrically connected to the communication interface and the storage device, and configured to decode the encoded volumetric mesh. The processor is configured to obtain a geometry bitstream, and the processor is configured to decode a base mesh from the geometry bitstream. The processor is configured to recursively subdividing the base mesh to a level-of-detail, and the processor is configured to obtain a coded bitstream for a plurality of mesh displacements from the base mesh recursively subdivided to the level-of-detail. The processor is configured to decode the coded bitstream with a codec corresponding to a mesh codec identification of the decoder to obtain a plurality of transformed displacement coefficients, and the processor is configured to process the plurality of transformed displacement coefficients with an inverse displacement transform to generate the plurality of mesh displacements. The processor is configured to apply the plurality of mesh displacements to the recursively subdivided base mesh to generate a reconstructed mesh including blocks representing individual region of interest.

The computer-readable storage medium of the invention stores a computer program, and the computer program is used to be executed by a processor of an encoder to implement the above encoding method.

The computer-readable storage medium of the invention stores a computer program, and the computer program is used to be executed by a processor of a decoder to implement the above decoding method.

### BRIEF DESCRIPTION OF THE DRAWINGS

FIG. 1 is a schematic diagram of a hardware structure of an encoder according to an embodiment of the invention.

FIG. 2 is an implementation diagram of a codec architecture according to an embodiment of the invention.

FIG. 3 is a flow chart of an encoding method according to an embodiment of the invention.

FIG. 4A is a schematic diagram of a base mesh according to an embodiment of the invention.

FIG. 4B is a schematic diagram of determining a plurality of subdivided points of the base mesh of FIG. 4A according to an embodiment of the invention.

FIG. 4C is a schematic diagram of determining a plurality of mesh displacements of the base mesh of FIG. 4B according to an embodiment of the invention.

FIG. 5 is a schematic diagram of a mesh displacement in a three-dimension space according to an embodiment of the invention.

FIG. 6A to FIG. 6C are schematic diagrams of geometry component coding according to an embodiment of the invention.

FIG. 7A is a schematic diagram of a two-dimensional image according to an embodiment of the invention.

FIG. 7B is a schematic diagram of a two-dimensional image according to another embodiment of the invention.

FIG. 8 is a schematic diagram of a hardware structure of a decoder according to an embodiment of the invention.

FIG. 9 is a flow chart of a decoding method according to an embodiment of the invention.

### DESCRIPTION OF THE EMBODIMENTS

In order to have a more detailed understanding of the characteristics and technical content of the embodiments of the present application, the implementation of the embodiments of the present application will be described in detail below with reference to the accompanying drawings. The attached drawings are for reference and explanation purposes only, and are not used to limit the embodiments of the present application.

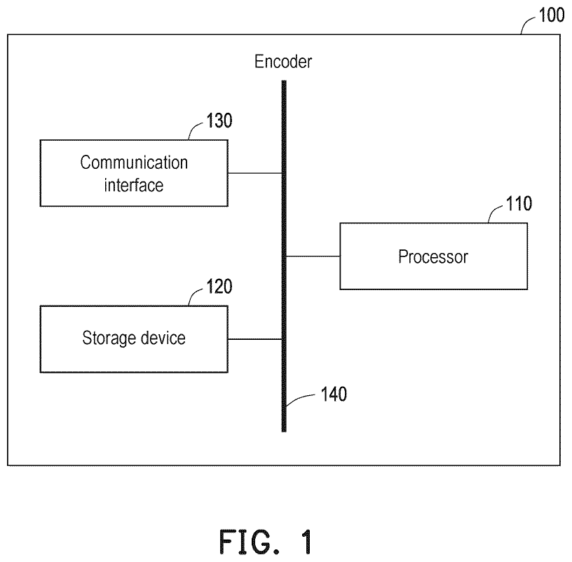

FIG. 1 is a schematic diagram of a hardware structure of an encoder according to an embodiment of the invention. Referring to FIG. 1, the encoder 100 includes a processor 110, a storage device 120, a communication interface 130, and a data bus 140. The processor 110 is electrically connected to the storage device 120, the communication interface 130 through the data bus 140. In the embodiment of the invention, the storage device 120 may store relevant instructions, and may further store relevant volumetric mesh encoders of algorithms. The processor 110 may receive the bitstream from the communication interface 130. The processor 110 may execute the relevant volumetric mesh encoders and/or the relevant instructions to implement encoding methods of the invention. In the embodiment of the invention, the encoder 100 may be implemented by one or more personal computer (PC), one or more server computer, and one or more workstation computer or composed of multiple computing devices, but the invention is not limited thereto. In one embodiment of the invention, the encoder 100 may include more processors for executing the relevant volumetric mesh encoders and/or the relevant instructions to implement the volumetric mesh data processing method of the invention. In addition, in one embodiment of the invention, the encoder 100 may include more processors for executing the relevant volumetric mesh encoders, the relevant volumetric mesh decoders and/or the relevant instructions to implement the encoding method of the invention. The encoder 100 may be used to implement a volumetric mesh codec, and can perform a volumetric mesh data encoding function and a volumetric mesh data decoding function in the invention.

In the embodiment of the invention, the processor 110 may include, for example, a central processing unit (CPU), a graphic processing unit (GPU), or other programmable general-purpose or special-purpose microprocessor, digital signal processor (DSP), application specific integrated circuit (ASIC), programmable logic device (PLD), other similar processing circuits or a combination of these devices. In the embodiment of the invention, the storage device 120 may be a non-transitory computer-readable storage medium, such as a read-only memory (ROM), an erasable programmable read-only memory (EPROM), an electrically-erasable programmable read-only memory (EEPROM) or a non-volatile memory (NVM), but the present invention is not limited thereto. In one embodiment of the invention, the relevant volumetric mesh encoders and/or the relevant instructions may also be stored in the non-transitory computer-readable storage medium of one apparatus, and executed by the processor of another one apparatus. The communication interface 130 is, for example, a network card that supports wired network connections such as Ethernet, a wireless network card that supports wireless communication standards such as Institute of Electrical and Electronics Engineers (IEEE) 802.11n/b/g/ac/ax/be, or any other network connecting device, but the embodiment is not limited thereto. The communication interface 130 is configured to retrieve a volumetric mesh (or dynamic volumetric mesh series). In the embodiment of the invention, the processor 110 may encode the three-dimensional volumetric mesh for applications such as augmented reality (AR) or video processing.

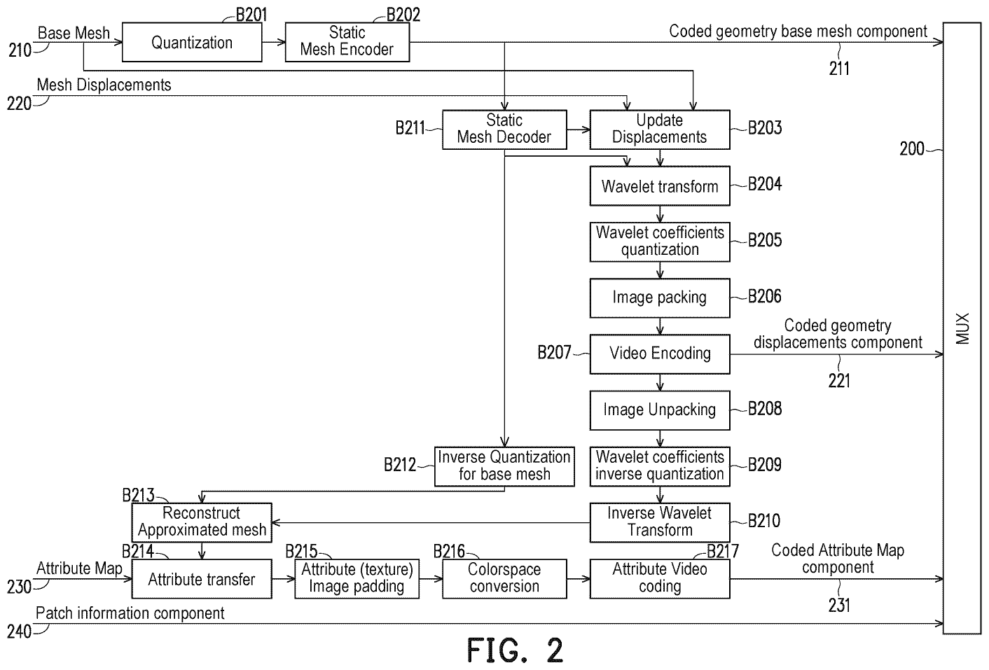

FIG. 2 is an implementation diagram of a codec architecture according to an embodiment of the invention. Referring to FIG. 1 and FIG. 2, the encoder 100 may encode volumetric mesh (three-dimensional image) to a coded bitstream with two-dimensional image data by performing the coding process of the encoder architecture of FIG. 2. In the embodiment of the invention, the processor 110 may pre-process, for example, a three-dimensional mesh model corresponding to a three-dimensional object to generate a plurality of base meshes 210, a plurality of mesh displacements 220 (i.e. geometry displacements), a plurality of attribute maps 230 and a patch information component 240. The processor 110 may subdivide the plurality of base meshes 210 to generate the plurality of previously reconstructed meshes. In block B201, the processor 110 may quantize the plurality of previously reconstructed meshes to generate a plurality of quantized base meshes. In block B202, the processor 110 may encode the plurality of quantized base meshes by using a static mesh encoder to generate a coded geometry base mesh component 211 of the bitstream to a multiplexer 200. In block B203, the processor 110 may update the plurality of mesh displacements 220. In block B204, the processor 110 may execute a wavelet transform on the plurality of mesh displacements 220 to generate a plurality of wavelet transform coefficients. In block B205, the processor 110 may quantize the plurality of wavelet transform coefficients to generate to a plurality of quantized wavelet coefficients. In block B206, the processor 110 may perform an image packing on the plurality of quantized wavelet coefficients. In block B207, the processor 110 may perform video encoding on packed data to generate a geometry displacements component. In block B208, the processor 110 may perform image unpacking on the packed data to generate the plurality of quantized wavelet coefficients (which may be the same as the original quantized wavelet coefficients before packing). In block B209, the processor 110 may perform a wavelet coefficient inverse quantization on the plurality of quantized wavelet coefficients to generate the plurality of wavelet coefficients (which may be the same as the original wavelet coefficients before quantization). In block B210, the processor 110 may perform an inverse wavelet transform on the plurality of wavelet coefficients to generate the plurality of corresponding mesh displacements (which may be the same as the mesh displacements before encoding).

In block B211, the processor 110 may decode the coded geometry base mesh component 211 to generate a plurality of quantized base meshes (which may be the same as the quantized base meshes before encoding) by using a static mesh decoder. In block B212, the processor 110 may inversely quantize the plurality of quantized base meshes to generate a plurality of base meshes (which may be the same as the base meshes before encoding). In block B213, the processor 110 may reconstruct an approximated mesh according to the plurality of mesh displacements and the plurality of base meshes.

In block B214, the processor 110 may execute an attribute transfer on an attribute map according to the approximated mesh to generate a transferred attribute map. In block B215, the processor 110 may perform attribute image padding on the transferred attribute map. In block B216, the processor 110 may perform a color space conversion on the transferred attribute map. In block B217, the processor 110 may perform attribute video coding on the transferred attribute map. Thus, the processor 110 may generate a coded attribute map component 231 of the bitstream to the multiplexer 200. Moreover, the processor 110 may provide the patch information component of the bitstream to the multiplexer 200. Therefore, the multiplexer 200 may sequentially output the coded base mesh component 211, the coded displacement component 221, the coded attribute map component 231 and the patch information component 240 of the bitstream.

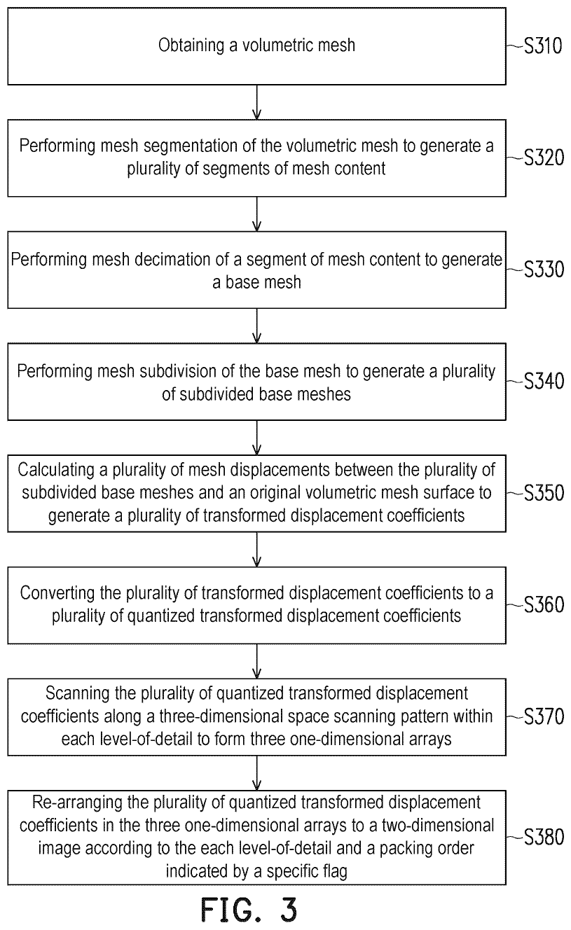

FIG. 3 is a flow chart of an encoding method according to an embodiment of the invention. Referring to FIG. 1 and FIG. 3, the processor 110 may execute the following steps S310 to S370 to implement the image packing of the above block B206 of FIG. 2. In step S310, the processor 110 may obtain a volumetric mesh (three-dimensional image). In step S320, the processor 110 may perform mesh segmentation of the volumetric mesh to generate a plurality of segments of mesh content (i.e., sub-meshes). The plurality of sub-meshes may represent individual objects/regions of interest/volumetric tiles, semantic blocks, etc. In step S330, the processor 110 may perform mesh decimation of a segment of mesh content to generate a base mesh (for the sub-mesh). The processor 110 may perform the mesh decimation of a segment of mesh content to generate the base mesh coded with an undefined static mesh encoder. In step S340, the processor 110 may perform mesh subdivision of the base mesh to generate a plurality of subdivisions of the base mesh (i.e., subdivided base meshes). In step S350, the processor 110 may calculate a plurality of mesh displacements between the plurality of subdivisions of the base mesh (i.e., subdivided base meshes) and an original volumetric mesh surface (i.e. sub-meshes) to generate a plurality of transformed displacement coefficients (e.g. wavelet coefficients). The processor 110 may perform a displacement transform (e.g. wavelet transform) on the plurality of mesh displacements to generate a plurality of transformed displacement coefficients. In the embodiment of the invention, the processor 110 may read the flag (e.g. dmsps_mesh_transform_width_minus_1) in the bitstream. The flag (e.g. dmsps_mesh_transform_width_minus_1) may indicate the number of subdivisions, where the number of subdivisions may equal to the value of the flag (e.g. dmsps_mesh_transform_width_minus_1) plus 1.

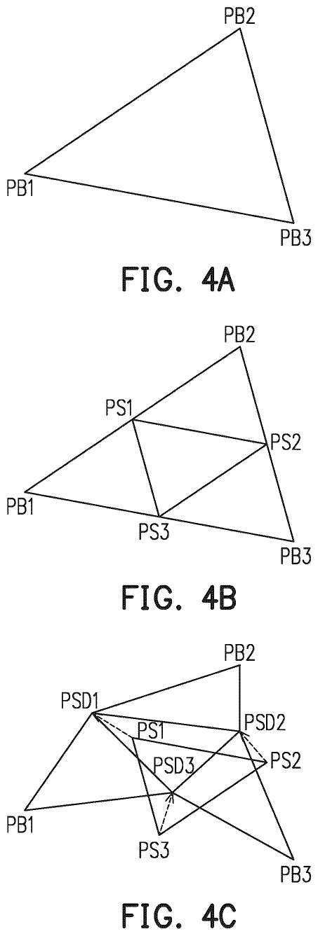

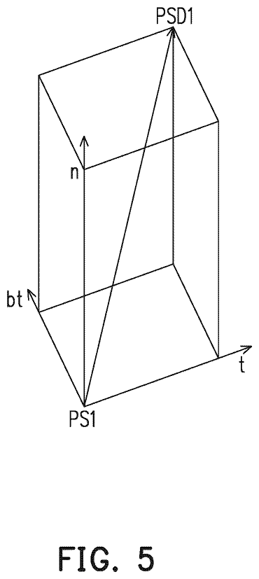

For example, referring to FIG. 4A, the base mesh may consist of the base mesh points PB1, PB2 and PB3. Referring to FIG. 4B, the processor 110 may further determine the subdivided points PS1, PS2 and PS3 according to the base mesh points PB1, PB2 and PB3. The subdivided point PS1 may be calculated as a mid-point between the base mesh points PB1 and PB2. The subdivided point PS2 may be calculated as a mid-point between the base mesh points PB2 and PB3. The subdivided point PS3 may be calculated as a mid-point between the base mesh points PB1 and PB3. Then, the processor 110 may calculate the mesh displacements between a surface of the mesh model and the plurality of previously reconstructed meshes. Referring to FIG. 4C, the processor 110 may determine the subdivided displaced points PSD1, PSD2 and PSD3. Thus, the mesh displacements may be determined by the vectors between the subdivided point PS1 and the subdivided displaced points PSD1, between the subdivided point PS2 and the subdivided displaced points PSD2, and between the subdivided point PS3 and the subdivided displaced points PSD3. Referring to FIG. 5, the mesh displacement between the subdivided point PS1 and the subdivided displaced points PSD1 may be described by a coordinate system of a three-dimensional space as shown in FIG. 5. The three-dimension space may be composed by a bitangent axis (bt), a tangent axis (t) and a normal axis (n).

In step S360, the processor 110 may convert the plurality of transformed displacement coefficients to a plurality of quantized transformed displacement coefficients. In the embodiment of the invention, the processor 110 may convert the plurality of transformed displacement coefficients to a fix-point representation with a precision indicated in the coded bitstream at the slice, picture, or sequence-level, the fixed-point representation being the quantized transformed displacement coefficients. In step S370, the processor 110 may scan the plurality of quantized transformed displacement coefficients along a three-dimensional space scanning pattern within each level-of-detail to form three one-dimensional arrays per component of the volumetric mesh. In the embodiment of the invention, the three-dimensional space scanning pattern may be a Morton space filling curve, a Hibert space filling curve or other space filling curve, and the invention is not limited thereto. In step S380, the processor 110 may re-arrange the plurality of quantized transformed displacement coefficients (i.e. displacement components) in the three one-dimensional arrays to a two-dimensional image according to the each level-of-detail and a packing order indicated by a specific flag.

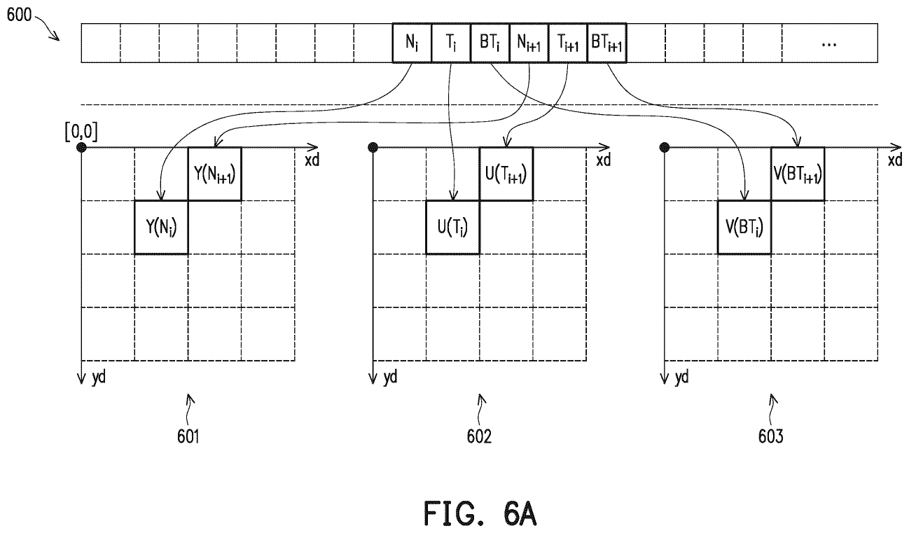

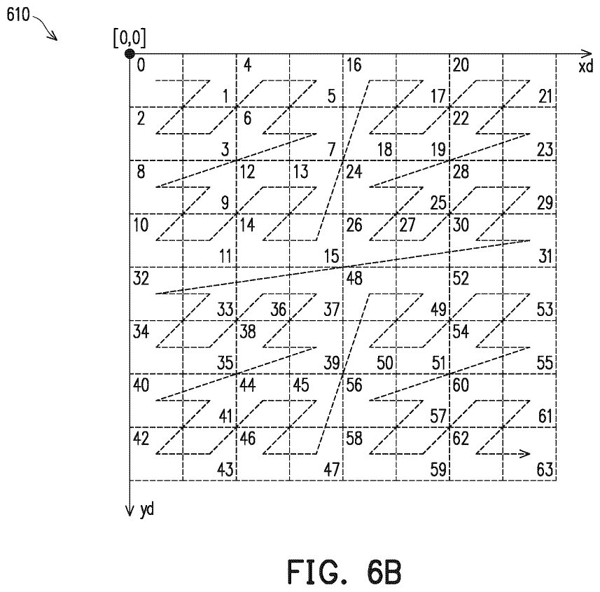

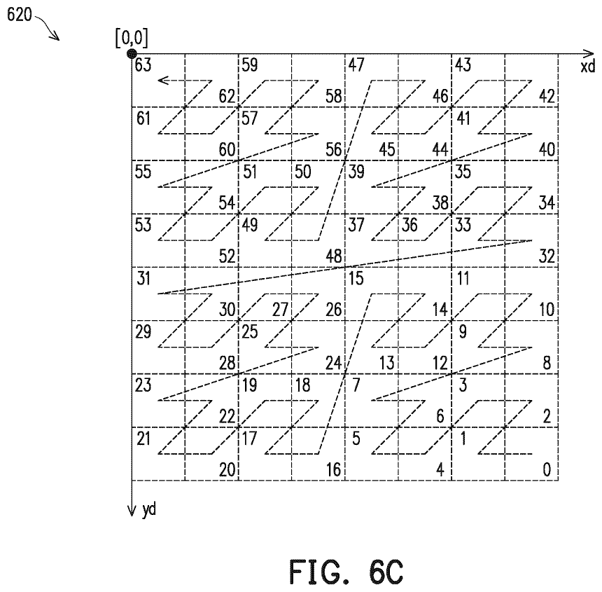

FIG. 6A to FIG. 6C are schematic diagrams of geometry component coding according to an embodiment of the invention. Referring to FIG. 1 and FIG. 6A, for example, the processor 110 may re-arrange a plurality of transformed displacement components from an one-dimensional array 600 to a plurality of two-dimensional images 601 to 603 based on YUV444 color mapping. Each unit vector component may be associated with a different color plane. As show in FIG. 6A, the transformed displacement components Nᵢ and Nᵢ₊₁ (corresponding to the normal vector) may be mapped into two blocks Y(Nᵢ) and Y(Nᵢ₊₁) on the Y-plane, where i is a morton code index for the displacement coefficient (e.g. i=3). The transformed displacement components Tᵢ and Tᵢ₊₁ (corresponding to the tangent vector) may be mapped into two blocks U(Tᵢ) and U(Tᵢ₊₁) on the U-plane. The transformed displacement components BTᵢ and BTᵢ₊₁ (corresponding to the bitangent vector) may be mapped into two blocks V(BTᵢ) and V(BTᵢ₊₁) on the V-plane. However, in the embodiment of the invention, referring to FIG. 1 and FIG. 6B, the processor 110 may execute forward packing to continuously allocate the all transformed displacement components (i.e. the quantized transformed displacement coefficients) into one two-dimensional image 610 (8×8 packing blocks). Or, in one embodiment of the invention, referring to FIG. 1 and FIG. 6C, the processor 110 may also execute backward packing to continuously allocate the all transformed displacement components (i.e. the quantized transformed displacement coefficients) into one two-dimensional image 620 (8×8 packing blocks).

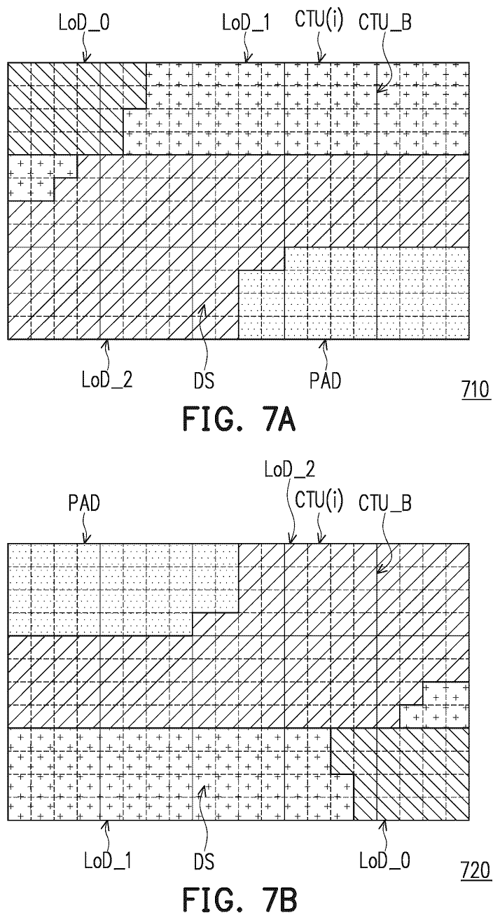

Specifically, referring to FIG. 7A, FIG. 7A is a schematic diagram of a two-dimensional image according to an embodiment of the invention. The two-dimensional image 710 is composed of a plurality of coding tree units (CTU) CTU(i), where i is a positive integer. Each one of the CTUs CTU(i) may correspond to a displacement sample DS. The processor 110 may read the specific flag (e.g. dmsps_packing_order) in the bitstream. The specific flag (e.g. dmsps_packing_order) may indicate the displacement transform population direction for coefficients used in the displacement component. As show in FIG. 7A, in response to the specific flag (e.g. dmsps_packing_order) being equal to 0, the packing order is an increasing level-of-detail order. The processor 110 may sequentially pack the level-of-detail LoD_0 to the level-of-detail LoD_2 (packing from low level to high level) into the two-dimensional image 710 from the point (0, 0) in the two-dimensional image 710 (i.e. packing from the start of the image), and there are CTU boundaries CTU_B between the level-of-details LoD_0 to LoD_2. In addition, in response to that the two-dimensional image 710 may include at least one unoccupied symbol PAD, the at least one unoccupied symbol PAD may be padded by, for example, zero-padding, but the invention is not limited thereto.

Then, referring to FIG. 7B, FIG. 7B is a schematic diagram of a two-dimensional image according to another embodiment of the invention. In response to the specific flag (e.g. dmsps_packing_order) being equal to 1, the packing order is a decreasing level-of-detail order. The processor 110 may sequentially pack the level-of-detail LoD_2 to the level-of-detail LoD_1 (packing from high level to low level) into the two-dimensional image 720 from the point (W-1, H-1) in the two-dimensional image 720 (i.e. packing from the end of the image), and there are CTU boundaries CTU_B between the level-of-details LoD_0 to LoD_2. “W-1” is an image width of the two-dimensional image 720, and the “H-1” is an image high of the two-dimensional image 720.

Therefore, the encoder 100 may re-arrange the plurality of quantized transformed displacement coefficients into the two-dimensional image 710 or the two-dimensional image 720 by the increasing level-of-detail order or the decreasing level-of-detail order according to the specific flag, so that in the subsequent encoding or decoding process, the processor 110 or other processor may determine whether to start reading from the high-order level-of-detail or the low-order level-of-detail according to different needs to achieve efficient image encoding or image decoding.

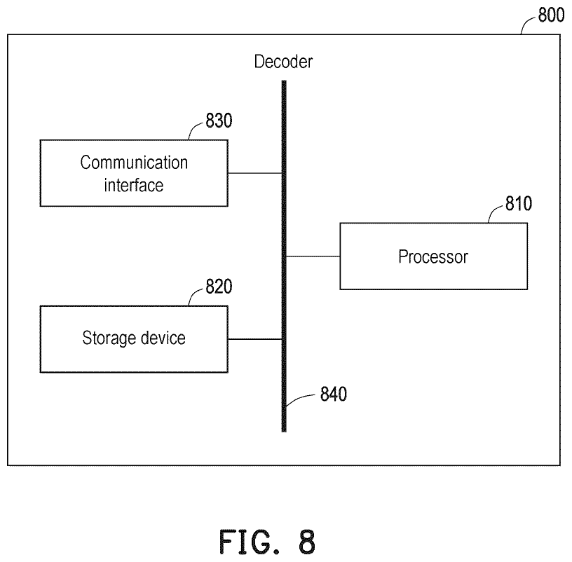

FIG. 8 is a schematic diagram of a hardware structure of a decoder according to an embodiment of the invention. Referring to FIG. 8, the decoder 800 includes a processor 810, a storage device 820, a communication interface 830, and a data bus 840. The processor 810 is electrically connected to the storage device 820, the communication interface 830 through the data bus 840. In the embodiment of the invention, the storage device 820 may store relevant instructions, and may further store algorithms of relevant volumetric mesh decoders. The processor 810 may receive the encoded volumetric mesh or the bitstream from the communication interface 830. The processor 810 may execute the relevant volumetric mesh decoders and/or the relevant instructions to implement decoding methods of the invention. In the embodiment of the invention, the decoder 800 may be implemented by one or more personal computer (PC), one or more server computer, and one or more workstation computer or composed of multiple computing devices, but the invention is not limited thereto. In one embodiment of the invention, the decoder 800 may include more processors for executing the relevant volumetric mesh decoders and/or the relevant instructions to implement the volumetric mesh data processing method of the invention. In one embodiment of the invention, the decoder 800 may include more processors for executing the relevant volumetric mesh encoders, the relevant volumetric mesh decoders and/or the relevant instructions to implement the encoding method of the invention. The decoder 800 may be used to implement a volumetric mesh codec, and can perform a volumetric mesh data encoding function and a volumetric mesh data decoding function in the invention.

In the embodiment of the invention, the processor 810 may include, for example, a central processing unit (CPU), a graphic processing unit (GPU), or other programmable general-purpose or special-purpose microprocessor, digital signal processor (DSP), application specific integrated circuit (ASIC), programmable logic device (PLD), other similar processing circuits or a combination of these devices. In the embodiment of the invention, the storage device 820 may be a non-transitory computer-readable storage medium, such as a read-only memory (ROM), an erasable programmable read-only memory (EPROM), an electrically-erasable programmable read-only memory (EEPROM) or a non-volatile memory (NVM), but the present invention is not limited thereto. In one embodiment of the invention, the relevant volumetric mesh decoders and/or the relevant instructions may also be stored in the non-transitory computer-readable storage medium of one apparatus, and executed by the processor of another one apparatus. The communication interface 830 is, for example, a network card that supports wired network connections such as Ethernet, a wireless network card that supports wireless communication standards such as Institute of Electrical and Electronics Engineers (IEEE) 802.11n/b/g/ac/ax/be, or any other network connecting device, but the embodiment is not limited thereto. The communication interface 830 is configured to retrieve bitstream. In the embodiment of the invention, the bitstream may include encoded values of geometry bitstream and attribute bitstream. The attribute bitstream may further include encoded values of color level, reflectance level and/or zero-run length.

In the embodiment of the invention, the decoder 800 may implement the image unpacking of the above block B209 of FIG. 2. In one embodiment of the invention, the decoder 800 and the encoder 100 of FIG. 1 may be the same codec. In another embodiment of the invention, the decoder 800 also may be implement as a receiver end (RX) for decoding and displaying the volumetric mesh (three-dimensional image) (e.g. a display device or a terminal device), and the encoder 100 of FIG. 1 may be implement as a transmitter end (TX) for encoding and outputting the encoded bitstream (e.g. a volumetric mesh data source). The encoder 100 of FIG. 1 may encode volumetric mesh (three-dimensional image) data to the coded bitstream, and the decoder 800 may receive the coded bitstream from the encoder 100 of FIG. 1. The decoder 800 may decode the coded bitstream to a base mesh and corresponding mesh displacements, so as to generate the volumetric mesh (three-dimensional image) for applications such as augmented reality (AR) or video processing.

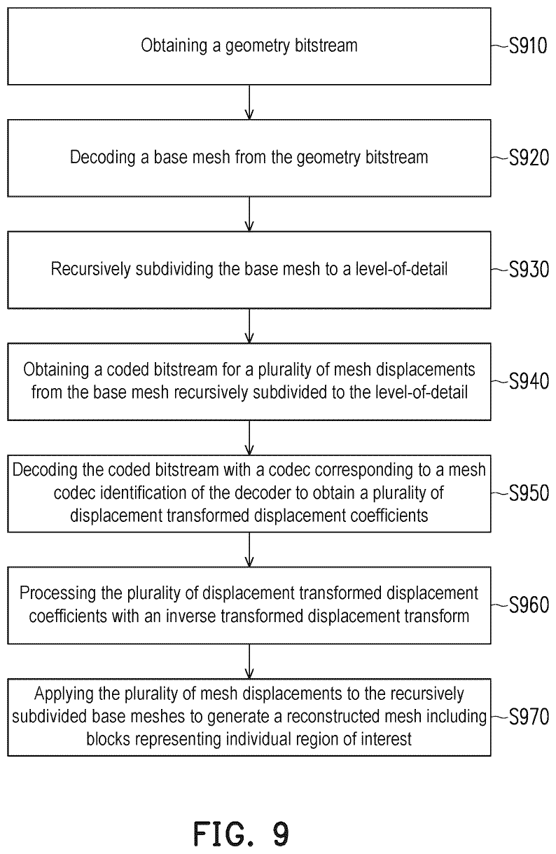

FIG. 9 is a flow chart of a decoding method according to an embodiment of the invention. Referring to FIG. 8 and FIG. 9, the processor 810 of the decoder 800 may receive the bitstream provided from the encoder 100 of FIG. 1 or the multiplexer 200 of FIG. 2 may execute the following steps S910 to S970 to implement the decoding of the mesh displacement. In step S910, the processor 810 may obtain an encoded volumetric mesh including a geometry bitstream. In step S920, the processor 810 may decode a base mesh from the geometry bitstream. In step S930, the processor 810 may recursively subdivide the base mesh to a level-of-detail defined by an encoder. In step S940, the processor 810 may obtain a coded bitstream for a plurality of geometry displacements from the base mesh recursively subdivided to the level-of-detail defined by the encoder. In step S950, the processor 810 may decode the coded bitstream with a codec corresponding to a mesh codec identification of the decoder to obtain the plurality of displacement transformed displacement coefficients. In step S960, the processor 810 may process the displacement transformed displacement coefficients with an inverse displacement transform. In step S970, the processor 810 may apply the plurality of mesh displacements to the recursively subdivided base meshes to generate a reconstructed mesh including blocks representing individual region of interest.

In the embodiment of the invention, the plurality of transformed displacement coefficients is converted from the plurality of quantized transformed displacement coefficients, and the plurality of quantized transformed displacement coefficients may be coded in, for example, the two-dimensional image 600 of FIG. 6 or the two-dimensional image 700 of FIG. 7. Therefore, in the subsequent encoding or decoding process, the processor 910 may determine whether to start reading from the high-order level-of-detail or the low-order level-of-detail according to different needs to achieve efficient image encoding or image decoding. In addition, in the embodiment of the invention, for relevant technical features, may refer to the description of the above embodiments of FIG. 1 to FIG. 7, and will not be described again here.

In summary, the encoding method, the decoding method, the encoder and the decoder of the invention can implement high-efficiency image encoding and image decoding operations of the displacement components by selectively using the increasing level-of-detail order or the decreasing level-of-detail order to pack the plurality of quantized transformed displacement coefficients according to different encoding and decoding requirements.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

### REFERENCE SIGNS LIST

100: Encoder
110, 810: Processor
120, 820: Storage device
130, 830: Communication interface
140, 840: Data bus
200: Multiplexer
210: Base mesh
211: Coded geometry base mesh component
220: Mesh displacement
221: Coded displacement component
230: Attribute map
231: Coded attribute map component
240: Patch information component
B201˜B217: Block
S310˜S370, S910˜S970: Step
PB1, PB2, PB3: Base mesh point
PS1, PS2, PS3: Subdivided point
PSD1, PSD2, PSD3: Subdivided displaced point
n: Normal axis
bt: Bitangent axis
t: Tangent axis
LoD_0, LoD_1, LoD_2: Level-of-detail
DS: Displacement sample
PAD: Unoccupied symbol
CTU(i): Coding tree unit
CTU_B: CTU boundary
600, 700: Two-dimensional image
800: Decoder

1. An encoding method, comprising:
obtaining, by a processor, a volumetric mesh;
performing, by the processor, mesh segmentation of the volumetric mesh to generate a plurality of segments of mesh content;
performing, by the processor, mesh decimation of a segment of mesh content to generate a base mesh;
performing, by the processor, mesh subdivision of the base mesh to generate a plurality of subdivided base meshes;
calculating, by the processor, a plurality of mesh displacements between the plurality of subdivided base meshes and an original volumetric mesh surface to generate a plurality of transformed displacement coefficients;
converting, by the processor, the plurality of transformed displacement coefficients to a plurality of quantized transformed displacement coefficients;
scanning, by the processor, the plurality of quantized transformed displacement coefficients along a three-dimensional space scanning pattern within each level-of-detail to form three one-dimensional arrays; and
re-arranging, by the processor, the plurality of quantized transformed displacement coefficients in the three one-dimensional arrays to a two-dimensional image according to the each level-of-detail and a packing order indicated by a specific flag.

2. The encoding method according to claim 1, wherein in response to the specific flag being equal to 0, the packing order is an increasing level-of-detail order, and
in response to the specific flag being equal to 1, the packing order is a decreasing level-of-detail order.

3. The encoding method according to claim 1, wherein the plurality of transformed displacement coefficients are converted to a fix-point representation with a precision indicated in a coded bitstream.

4. The encoding method according to claim 1, wherein the three-dimensional space scanning pattern is a Morton space filling curve or a Hibert space filling curve.

5. The encoding method according to claim 1, wherein the two-dimensional image is composed of a plurality of coding tree units.

6. The encoding method according to claim 5, wherein in response to the two-dimensional image including at least one unoccupied symbol, the at least one unoccupied symbol is padded.

7. The encoding method according to claim 6, wherein the at least one unoccupied symbol is padded by zero-padding.

8-14. (canceled)

15. A decoding method, comprising:
obtaining, by a processor, a geometry bitstream;
decoding, by the processor, a base mesh from the geometry bitstream;
recursively subdividing, by the processor, the base mesh to a level-of-detail;
obtaining, by the processor, a coded bitstream for a plurality of mesh displacements from the base mesh recursively subdivided to the level-of-detail;
decoding, by the processor, the coded bitstream with a codec corresponding to a mesh codec identification of the decoder to obtain a plurality of transformed displacement coefficients;
processing, by the processor, the plurality of transformed displacement coefficients with an inverse displacement transform to generate the plurality of mesh displacements; and
applying, by the processor, the plurality of mesh displacements to the recursively subdivided base meshes to generate a reconstructed mesh including blocks representing individual region of interest.

16. The decoding method according to claim 15, wherein the plurality of transformed displacement coefficients is converted from a plurality of quantized transformed displacement coefficients, and the plurality of quantized transformed displacement coefficients is coded in a two-dimensional image,
wherein the two-dimensional image is generated according to each level-of-detail and a packing order indicated by a specific flag.

17. The decoding method according to claim 16, wherein in response to the specific flag being equal to 0, the packing order is an increasing level-of-detail order, and
in response to the specific flag being equal to 1, the packing order is a decreasing level-of-detail order.

18. The decoding method according to claim 17, wherein the two-dimensional image is composed of a plurality of coding tree units.

19. The decoding method according to claim 18, wherein in response to the two-dimensional image including at least one unoccupied symbol, the at least one unoccupied symbol is padded.

20. The decoding method according to claim 19, wherein the at least one unoccupied symbol is padded by zero-padding.

21. A decoder, comprising:
a communication interface, configured to receive a geometry bitstream;
a storage device, configured to store the geometry bitstream; and
a processor, electrically connected to the communication interface and the storage device, and configured to decode the geometry bitstream,
wherein the processor is configured to decode a base mesh from the geometry bitstream,
wherein the processor is configured to recursively subdivide the base mesh to a level-of-detail, and the processor is configured to obtain a coded bitstream for a plurality of mesh displacements from the base mesh recursively subdivided to the level-of-detail,
wherein the processor is configured to decode the coded bitstream with a codec corresponding to a mesh codec identification of the decoder to obtain a plurality of transformed displacement coefficients, and the processor is configured to process the plurality of transformed displacement coefficients with an inverse displacement transform to generate the plurality of mesh displacements,
wherein the processor is configured to apply the plurality of mesh displacements to the recursively subdivided base meshes to generate a reconstructed mesh including blocks representing individual region of interest.

22. The decoder according to claim 21, wherein the plurality of transformed displacement coefficients is converted from a plurality of quantized transformed displacement coefficients, and the plurality of quantized transformed displacement coefficients is coded in a two-dimensional image,
wherein the two-dimensional image is generated according to each level-of-detail and a packing order indicated by a specific flag.

23. The decoder according to claim 22, wherein in response to the specific flag being equal to 0, the packing order is an increasing level-of-detail order, and
in response to the specific flag being equal to 1, the packing order is a decreasing level-of-detail order.

24. The decoder according to claim 23, wherein the two-dimensional image is composed of a plurality of coding tree units.

25. The decoder according to claim 23, wherein in response to the two-dimensional image including at least one unoccupied symbol, the at least one unoccupied symbol is padded.

26. The decoder according to claim 25, wherein the at least one unoccupied symbol is padded by zero-padding.

27-28. (canceled)
